(19) United States
(12) Patent Application Publication
(10) Pub. No.: US 2010/0180257 A1
(43) Pub. Date: Jul. 15, 2010

(54) TESTING STM USING NON-STM CODE

(75) Inventor: Christopher W. Dern, Kirkland, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/351,948

(22) Filed: Jan. 12, 2009

(51) Int. Cl. G06F 11/36

(52) U.S. Cl. 717/124

(57) ABSTRACT

A software transactional memory (STM) test generator is provided that converts existing test code into test code that tests the functionality of an STM system. To generate the STM test code, the generator inserts transactional semantics into the existing test code and replaces any methods of the test code that are not supported by an STM system. The STM test code is compiled and executed to generate an STM test output, and the STM test output is compared to the output of the existing test code to produce STM test results.

### BACKGROUND

Computer programs may be written to allow different portions (e.g., threads) of the program to be executed concurrently. In order to execute different portions of the program concurrently, the computer system or the program typically includes some mechanism to manage the memory accesses of the different portions to ensure that the parts access common memory locations in the desired order.

Transactional memory systems allow programmers to designate transactions in a program that may be executed as if the transactions are executing in isolation (i.e., independently of other transactions and other sequences of instructions in the program). Transaction memory systems manage the memory accesses of transactions by executing the transactions in such a way that the effects of the transaction may be rolled back or undone if two or more transactions attempt to access the same memory location in a conflicting manner. Transaction memory systems may be implemented using hardware and/or software components.

Transactional memory systems may add complexity to a runtime environment of a computer system. The added complexity may increase the cost associated with verifying its intended functionality. It would be desirable to ensure the correct operation of a transactional memory system while minimizing the cost of doing so.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

A software transactional memory (STM) test generator is provided that converts existing test code into test code that tests the functionality of an STM system. To generate the STM test code, the generator inserts transactional semantics into the existing test code and replaces any methods of the test code that are not supported by an STM system. The STM test code is compiled and executed to generate an STM test output, and the STM test output is compared to the output of the existing test code to produce STM test results.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a block diagram illustrating an embodiment of an STM test generation system.

FIG. 2 is a flow chart illustrating an embodiment of a method for generating STM test code from non-STM test code.

FIG. 3 is a block diagram illustrating an embodiment of a compiler system with a compiler that is configured to compile STM and non-STM test code.

FIG. 4 is a block diagram illustrating an embodiment of a software transactional memory system that executes STM test code.

FIG. 5 is a block diagram illustrating an embodiment of a runtime system that executes non-STM test code.

FIG. 6 is a block diagram illustrating an embodiment of an output comparison module in a runtime environment of a computer system.

FIG. 7 is a block diagram illustrating an embodiment of a computer system configured to test a compiler system and/or an STM system.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

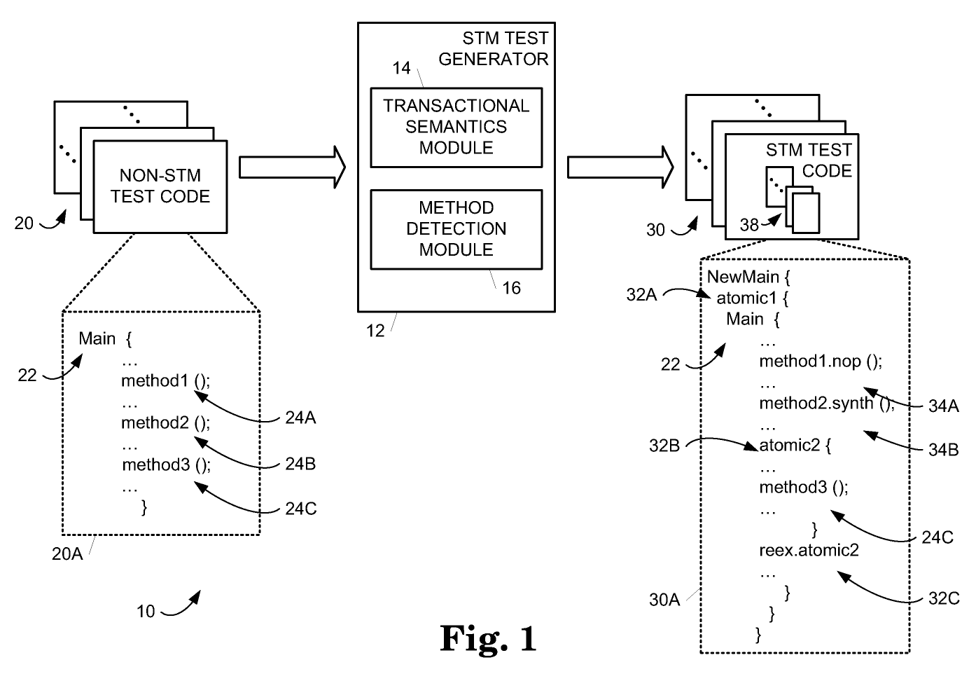

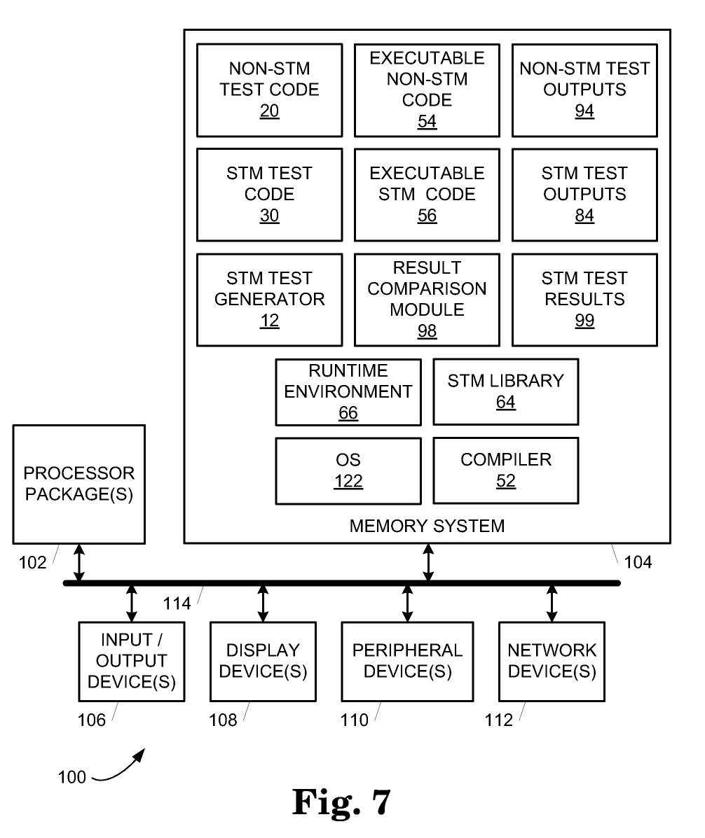

FIG. 1 is a block diagram illustrating an embodiment of a software transactional memory (STM) test generation system 10. STM test generation system 10 represents a runtime mode of operation in a computer system, such as computer system 100 shown in FIG. 7 and described in additional detail below, where the computer system is executing instructions to run STM test generator 12.

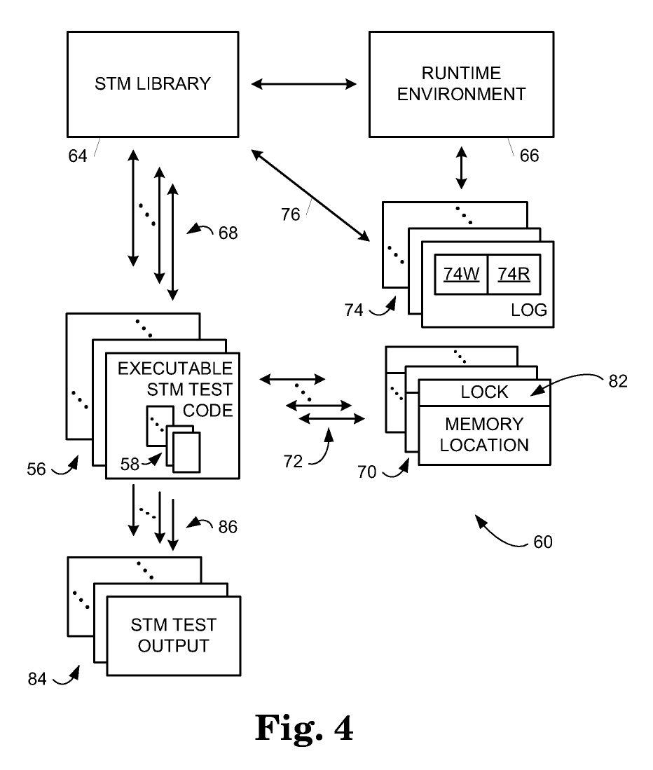

STM test generator 12 is configured to programmatically transform existing non-STM test code 20 into STM test code 30. As shown in FIG. 1, non-STM test code 20 may include any number of separate test programs that are not written to execute with an STM system, such as STM system 60 shown in FIG. 4 and described in additional detail below. As such, non-STM test code 20 does not include any transactions that are configured for atomic execution by an STM system.

STM test code 30 each include one or more transactions 38 that are configured for atomic execution by an STM system. Each transaction 38 includes a sequence of instructions that is designed to execute atomically, i.e., as if the sequence is executing in isolation from other transactional and non-transactional code in STM test code 30. When an STM test program 38 is executed by an STM system, the STM system tracks memory accesses of each executing transaction 38 to detect conflicting memory accesses by different transactions 38. The STM system may roll back and re-execute transactions 38 where a conflict is detected.

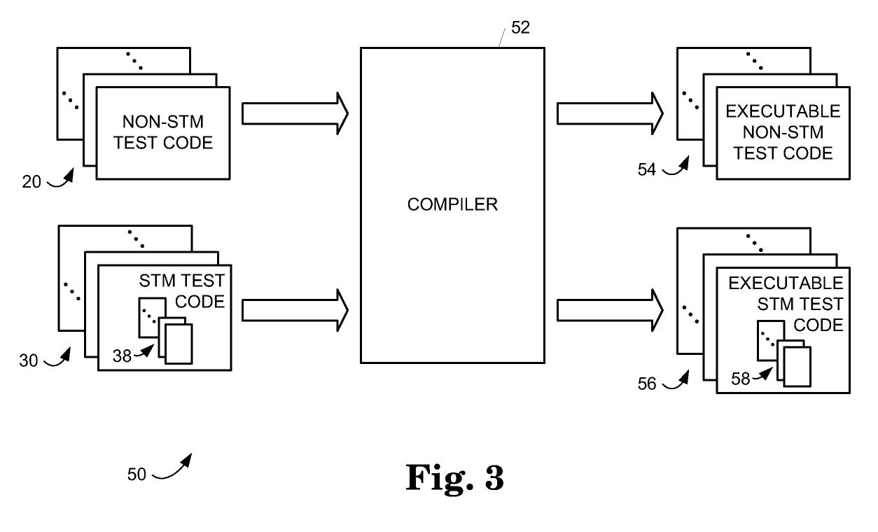

STM test generator 12 converts non-STM test code 20 into STM test code 30 to allow a compiler, such as compiler 52 shown in FIG. 3 and described in additional detail below, and/or an STM system to be tested. STM test generator 12 includes a transaction semantics module 14 and a method detection module 16. Transaction semantics module 14 is configured to insert transactional semantics 32 into non-STM test code 20 to generate STM test code 30. Transactional semantics 32 include programming constructs that are configured to invoke STM functions when executed. The STM functions include the creation, execution, and re-execution of transactions 38 and include the tracking of memory accesses by each transaction 38. Method detection module 16 is configured to detect and replace any method in non-STM test code 20 that is not supported by an STM system with a method that is supported by the STM system. Because STM systems roll back transactions 38 when conflicts are detected, STM systems do not support methods that modify data where the modifications cannot be undone. Such methods include, for example, input/output methods. Method detection module 16 replaces methods that are not suited for execution by an STM system with versions of the methods that are suited for execution by an STM system.

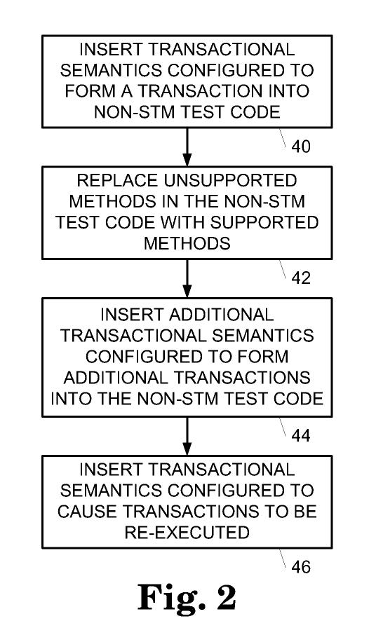

FIG. 2 is a flow chart illustrating an embodiment of a method for generating STM test code 30 from non-STM test code 20. The method of FIG. 2 will be described with reference to FIG. 1 where the functions are performed by STM test generator 12. The method of FIG. 2 may be performed separately for each non-STM test code 20 to generate a corresponding STM test code 30.

To generate STM test code 30A in the example of FIG. 1, STM test generator 12 inserts transactional semantics 32 configured to form a transaction 38 into non-STM code 20A as indicated in a block 40 as shown in FIG. 2. Transaction semantics module 14 detects the primary entry point 22 for non-STM code 20A (i.e., “Main”) and inserts transactional semantics 32A (e.g., an atomic designator and corresponding braces) into non-STM code 20A to generate STM test code 30A with a first transaction 38 to encompass the body of the non-STM code 20A. Transaction semantics module 14 may also insert additional method semantics (e.g., NewMain{ }) to encompass the transaction formed by transactional semantics 32A and cause a new method (e.g., NewMain) to be called to execute STM test code 30A. By doing so, transaction semantics module 14 encapsulates non-STM code 20A into a transaction 38 for execution by an STM system.

STM test generator 12 replaces unsupported methods 24 in non-STM code 20A with supported methods 34 as indicated in a block 42. Method detection module 16 performs a basic static functional analysis of non-STM code 20A to identify each method 24A, 24B, and 24C that will or may be called and determines whether each method 24A, 24B, and 24C is supported by an STM system. If a method 24 is not supported, then method detection module 16 replaces the method 24 with a method 34 that is supported by an STM system. If a method 24 is supported, then method detection module 16 may include the method 24 in STM code 30A without modification (e.g., method 24C shown in FIG. 1) to the method.

Supported methods 34 may be configured to suppress or emulate the functionality of the corresponding methods 24 that are replaced. For example, method detection module 16 may suppress an unsupported method 24A (i.e., method1) by replacing it with a supported method 34A (i.e., method.nop) that forms a no operation (nop). As another example, method detection module 16 may emulate an unsupported method 24B (i.e., method2) by replacing it with a supported method 34B (i.e., method.synth) that forms a synthesized version of unsupported method 24B.

STM test generator 12 inserts additional transactional semantics 32 configured to form additional transactions 38 into non-STM code 20 as indicated in a block 44. Transaction semantics module 14 may identify suitable locations in non-STM code 20 where additional transactions 38 may be inserted. For example, transaction semantics module 14 may nest a second transaction 38 into the first transaction 38 using transaction semantics 32B (e.g., an atomic designator and corresponding braces). Transaction semantics module 14 may also include additional nested or unnested transactions 38 (not shown).

STM test generator 12 inserts transactional semantics 32 configured to cause transactions 38 to be re-executed into non-STM code 20 as indicated in a block 46. In the example of FIG. 1, transaction semantics module 14 inserts transactional semantics 32C (i.e., reex.atomic2) to cause the transaction 38 formed by transactional semantics 32B to be re-executed by the STM system. The transactional semantics 32 used to cause a re-execution may include programming constructs configured to directly invoke the re-execution of a transaction 38 as shown in FIG. 1. The transactional semantics 32 used to cause a re-execution may also include programming constructs configured to cause a conflict to a memory location accessed by a transaction 38 to be detected to trigger the re-execution (not shown).

STM test generator 12 stores each STM test code 30 on a computer-readable medium accessible by a computer system. The computer-readable media may include any suitable type, number, and configuration of volatile or non-volatile storage devices configured to store instructions and data that are accessible and executable by a computer system. The computer system may be configured to compile and execute non-STM test code 20 and/or STM test code 30. The computer system may also be configured to transmit non-STM test code 20 and/or STM test code 30 to another computer-readable media for compilation and execution by another computer system.

FIG. 3 is a block diagram illustrating an embodiment of a compiler system 50 with a compiler 52 that is configured to compile non-STM test code 20 and STM test code 30.

Compiler system 50 represents a compile mode of operation in a computer system, such as computer system 100 shown in FIG. 7, where the computer system is executing instructions to compile non-STM test code 20 into executable non-STM test code 54 and/or compile STM test code 30 into executable STM test code 56. In one embodiment, compiler system 50 includes a just-in-time (JIT) compiler system that operates in the computer system in conjunction with a runtime environment (e.g., runtime environment 66 shown in FIGS. 4, 5, and 7) executed by an operating system (OS) (e.g., OS 122 shown in FIG. 7), an STM library (e.g., STM library 64 shown in FIGS. 4 and 7), and any additional runtime libraries (not shown). In another embodiment, compiler system 50 includes a stand-alone compiler system that produces non-STM test code 54 and STM test code 56 for execution on the same or a different computer system.

Non-STM test code 20 may be any suitable source code written in a language such as Java or C# or any suitable bytecode such as Common Intermediate Language (CIL), Microsoft Intermediate Language (MSIL), or Java bytecode. Compiler 52 accesses or otherwise receives non-STM test code 20 and compiles non-STM test code 20 into executable non-STM test code 54. Compiler 52 performs any desired conversion of the set of instructions of non-STM test code 20 into a set of instructions that are executable by a designated computer system and includes the set of instructions in executable non-STM test code 54. Compiler 52 stores executable non-STM test code 54 in a computer-readable medium accessible by the computer system.

As described above, STM test code 30 includes transactions 38 where each transaction 38 includes transactional semantics 32 that indicate to compiler 52 that a corresponding portion of code 30 is a transaction 38. Each STM transaction 38 may include zero or more memory accesses that read from and/or write to memory locations. STM test code 30 may be any suitable source code written in a language such as Java or C# or any suitable bytecode such as Common Intermediate Language (CIL), Microsoft Intermediate Language (MSIL), or Java bytecode.

Compiler 52 accesses or otherwise receives STM test code 30 with transactions 38. Compiler 52 identifies memory accesses and compiles STM test code 30 into executable STM test code 56 with invocations of STM primitives in an STM library for each transaction 58 and memory access. Compiler 52 performs any desired conversion of the set of instructions of STM test code 30 into a set of instructions that are executable by a designated computer system and includes the set of instructions in executable STM test code 56. Compiler 52 stores executable STM test code 56 in a computer-readable medium accessible by the computer system.

FIG. 4 is a block diagram illustrating an embodiment of STM system 60 that executes executable STM test code 56 with transactions 58. STM system 60 represents a runtime mode of operation in a computer system, such as computer system 100 shown in FIG. 7, where the computer system is executing instructions to run STM test code 56.

STM system 60 includes STM test code 56, an STM library 64, and a runtime environment 66. STM system 60 is configured to manage the execution of STM transactions 58 that form atomic blocks in STM test code 56 to allow transactions 58 to be executed atomically and, if desired, rollback or undo changes made by transactions 58. To do so, STM system 60 tracks memory accesses by transactions 58 to memory locations 70 using a log 74 for each executing transaction 58.

Transactions 58 include invocations of STM primitives, which may be added by a compiler such as compiler 52 shown in FIG. 3, that call functions in STM library 64. The STM primitives of STM library 64 return results to transactions 58 as indicated by function calls and returns 68.

STM library 64 includes STM primitives and instructions executable by the computer system in conjunction with runtime environment 66 to implement STM system 60. The STM primitives of STM library 64 that are callable by transactions 58 include management primitives that implement start, commit, abort, and retry functions in STM library 64. A transaction 58 calls the start function to initiate the management of the transaction 58 by STM library 64. A transaction 58 calls the commit function to finalize the results of the transaction 58 in memory locations 70, if successful. A transaction 58 calls the abort function to roll back or undo the results of the transaction 58 in memory locations 70. A transaction 58 calls the retry function to retry the transaction 58.

The STM primitives of STM library 64 that are callable by transactions 58 also include memory access primitives that manage accesses to memory locations 70 that are written and/or read by a transaction 58. The memory access primitives access a set of one or more transactional locks 82 for each memory locations 70. Each transactional lock 82 indicates whether a corresponding memory location 70 or portion of a corresponding memory location 70 is locked or unlocked for writing and/or reading. When a memory location 70 is locked for writing, the corresponding transactional lock 82 may include an address or other reference that locates an entry for the memory location 70 in a write log 74W. When a memory location 70 is not locked, the corresponding transactional lock 82 may include a version number of the memory location 70. Runtime environment 66 creates and manages the transactional lock(s) 82 for each memory location 70.

The memory access primitives of STM library 64 generate and manage a set of one or more STM logs 74 for each transaction currently being executed as indicated by arrow 76. Each set of STM logs 74 includes a write log 74W and a read log 74R that store information for write and read accesses, respectively, to allow corresponding transactions 58 to be rolled back, if necessary.

To access a memory location 70 for writing, the transaction 58 invokes a memory access primitive that opens the memory location 70 for writing. STM library 64 acquires a transactional lock 82 corresponding to the memory location 70 for the transaction 58 if the lock is available. If the memory location 70 is not available (i.e., the memory location 70 is locked by another transaction 58), then STM library 64 detects a memory access conflict between the current transaction 58 and the other transaction 58 and may rollback and re-execute the current transaction 58. If the memory location 70 is locked by the current transaction 58, then STM library 64 has already acquired the transactional lock 82 corresponding to the memory location 70 for the transaction 58. Once a corresponding transaction lock 42 is acquired, STM library 64 causes each write access 72 to be made to either the memory location 70 itself or a shadow copy of a corresponding memory location 70 (not shown) and causes an entry corresponding to the write access 72 to be stored in log 74W.

To access a memory location 70 for reading, the transaction 58 invokes a memory access primitive that opens the memory location 70 for reading. If the memory location 70 is not locked, STM library 64 causes an entry corresponding to the read access to be stored in read log 64R. If the memory location 70 is locked by another transaction 58, then STM library 64 detects a memory access conflict between the current transaction 58 and the other transaction 58 and may rollback and re-execute the current transaction 58. If the memory location 70 is locked by the current transaction 58, then STM library 64 may cause an entry corresponding to the read access to be stored in read log 74R or set a flag corresponding to the memory location 70 in write log 74W to indicate that the memory location 70 was also read. STM library 64 causes a read access 72 that occurs before a designated memory location 70 has been opened from writing by the transaction 58 to be made directly from the corresponding memory location 70. STM library 64 causes each read access 72 that occurs after a designated memory location 70 has been opened for writing by a transaction 58 to be made from either the corresponding memory location 70 directly or the corresponding shadow copy.

Subsequent to performing the memory accesses, STM library 64 allows the transaction 58 to begin commit processing to ensure that the memory accesses by the transaction 58 did not conflict with the memory accesses by any other transaction 58. The commit processing may include validating the read accesses of the transaction 58, updating any memory locations 70 that were modified by the transaction 58 with the shadow copies used to store the modifications, and/or storing an updated version number in any memory locations 70 that were modified by the transaction 58. If STM library 64 detects any memory access conflict between the current transaction 58 and another transaction 58, STM library 64 may rollback and re-execute the current transaction 58. Subsequent to performing the commit processing, STM library 64 allows the transaction 58 to complete if no conflicts are detected.

Runtime environment 66 may be any suitable combination of runtime libraries, a virtual machine (VM), an operating system (OS) functions, such as functions provided by OS 122 shown in FIG. 7, and/or compiler functions, such as functions provided by compiler 52 shown in FIGS. 3 and 7.

When executed, each STM test code 56 generates a corresponding STM test output 84, as indicated by arrows 86, that is stored in a computer-readable medium accessible by the computer system.

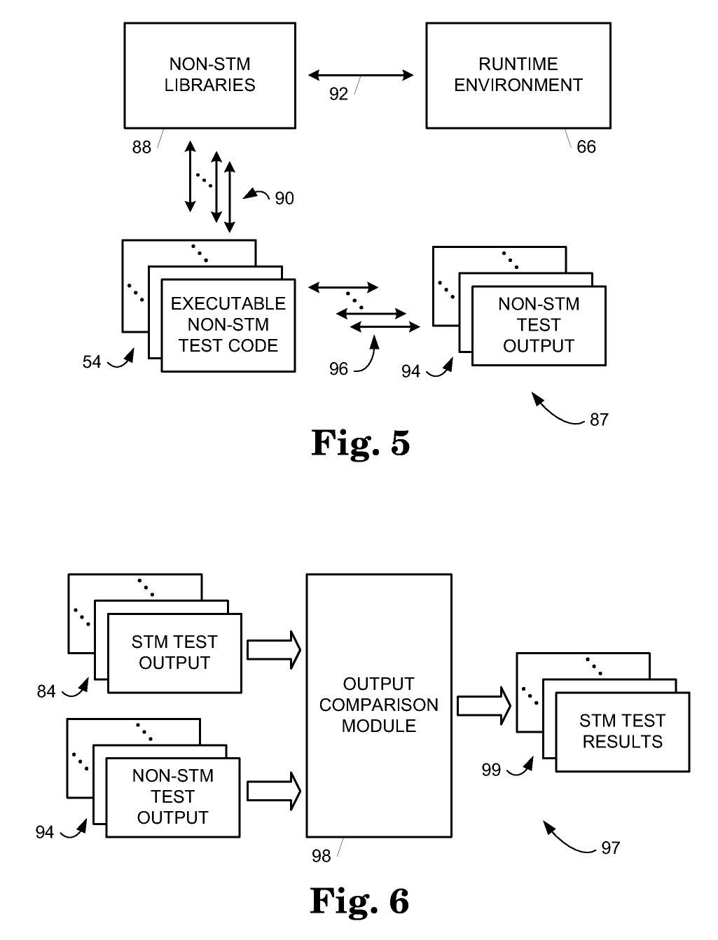

FIG. 5 is a block diagram illustrating an embodiment of a runtime system 87 that executes executable non-STM test code 54. Runtime system 87 represents a runtime mode of operation in a computer system, such as computer system 100 shown in FIG. 7, where the computer system is executing instructions to run non-STM test code 54.

Runtime system 87 includes non-STM test code 54, non-STM libraries 88, and runtime environment 66. Runtime system 87 manages the execution of non-STM test code 54. Non-STM test code 54 invokes functions in non-STM libraries 88 as indicated by function calls and returns 90. Non-STM libraries 88 operate in conjunction with runtime environment 66 as indicated by an arrow 92. Non-STM libraries 88 form any suitable library or combination of libraries that do not include functions configured to execute transactions or otherwise implement an STM system. When executed, each non-STM test code 54 generates a corresponding non-STM test output 94, as indicated by arrows 96, that is stored in a computer-readable medium accessible by the computer system.

FIG. 6 is a block diagram illustrating an embodiment of an output comparison system 97. Output comparison system 97 represents a runtime mode of operation in a computer system, such as computer system 100 shown in FIG. 7, where the computer system is executing instructions to run output comparison module 98.

Output comparison module 98 accesses or otherwise receives STM test outputs 84 and non-STM test outputs 84. Output comparison module 98 compares each STM test output 84 to a corresponding non-STM test output 94 to generate a corresponding STM test result 99 that is stored in a computer-readable medium accessible by the computer system. Output comparison module 98 determines whether STM test code 56 was correctly compiled by a compiler system and/or executed by an STM system by comparing the STM test output 84 for the STM test code 56 to a corresponding non-STM test output 94. In one embodiment, output comparison module 98 determines that STM test code 56 was correctly compiled and/or executed if the STM test output 84 and the non-STM test output 94 are identical and that STM test code 56 was incorrectly compiled and/or executed if the STM test output 84 and the non-STM test output 94 are not identical. In other embodiments, output comparison module 98 may determine that STM test code 56 was correctly compiled and/or executed if the STM test output 84 and the non-STM test output 94 differ only in expected ways and that STM test code 56 was incorrectly compiled and/or executed if the STM test output 84 and the non-STM test output 94 differ in unexpected ways.

By executing STM test code 56 and non-STM test code 54 and comparing the corresponding outputs 84 and 94 as described, STM test code 56 may be used to verify functionality of both a compiler system and an STM system. As a result, existing tests that were not written to test STM systems may be converted to STM test code to increase the function test coverage of both compiler systems and STM systems.

FIG. 7 is a block diagram illustrating an embodiment of computer system 100 configured to test a compiler system and/or an STM system.

Computer system 100 includes one or more processor packages 102, a memory system 104, zero or more input/output devices 106, zero or more display devices 108, zero or more peripheral devices 110, and zero or more network devices 112. Processor packages 102, memory system 104, input/output devices 106, display devices 108, peripheral devices 110, and network devices 112 communicate using a set of interconnections 114 that includes any suitable type, number, and configuration of controllers, buses, interfaces, and/or other wired or wireless connections.

Computer system 100 represents any suitable processing device configured for a general purpose or a specific purpose. Examples of computer system 100 include a server, a personal computer, a laptop computer, a tablet computer, a personal digital assistant (PDA), a mobile telephone, and an audio/video device. The components of computer system 100 (i.e., processor packages 102, memory system 104, input/output devices 106, display devices 108, peripheral devices 110, network devices 112, and interconnections 114) may be contained in a common housing (not shown) or in any suitable number of separate housings (not shown).

Processor packages 102 each include one or more execution cores. Each execution core is configured to access and execute instructions stored in memory system 104. The instructions may include a basic input output system (BIOS) or firmware (not shown), OS 122, compiler 52 (FIG. 3), STM library 64 (FIG. 4), and runtime environment 66 (FIGS. 4 and 5). The instructions also include STM test generator 12 (FIG. 1), non-STM test code 20 (FIG. 1), STM test code 30 (FIG. 1), executable non-STM test code 54 (FIG. 3), executable STM test code 56 (FIG. 3), STM test outputs 84 (FIG. 4), non-STM test outputs 94 (FIG. 4), result comparison module (FIG. 6), and STM test results 99 (FIG. 6). Each execution core may execute the instructions in conjunction with or in response to information received from input/output devices 106, display devices 108, peripheral devices 110, and/or network devices 112.

Computer system 100 boots and executes OS 122. OS 122 includes instructions executable by execution cores to manage the components of computer system 100 and provide a set of functions that allow programs to access and use the components. OS 122 executes runtime environment 66 to allow compiler 52, STM library 64, STM test generator 12, non-STM test code 20, STM test code 30, executable non-STM test code 54, executable STM test code 56, and result comparison module 98 to be executed. In one embodiment, OS 122 is the Windows operating system. In other embodiments, OS 122 is another operating system suitable for use with computer system 100.

Memory system 104 includes any suitable type, number, and configuration of volatile or non-volatile storage devices configured to store instructions and data. The storage devices of memory system 104 represent computer readable storage media that store computer-executable instructions including those shown in FIG. 7. The instructions are executable by computer system 100 to perform the functions and methods described herein. Memory system 104 stores instructions and data received from processor packages 102, input/output devices 106, display devices 108, peripheral devices 110, and network devices 112. Memory system 104 provides stored instructions and data to processor packages 102, input/output devices 106, display devices 108, peripheral devices 110, and network devices 112. Examples of storage devices in memory system 104 include hard disk drives, random access memory (RAM), read only memory (ROM), flash memory drives and cards, and magnetic and optical disks.

Input/output devices 106 include any suitable type, number, and configuration of input/output devices configured to input instructions or data from a user to computer system 100 and output instructions or data from computer system 100 to the user. Examples of input/output devices 106 include a keyboard, a mouse, a touchpad, a touchscreen, buttons, dials, knobs, and switches.

Display devices 108 include any suitable type, number, and configuration of display devices configured to output textual and/or graphical information to a user of computer system 100. Examples of display devices 108 include a monitor, a display screen, and a projector.

Peripheral devices 110 include any suitable type, number, and configuration of peripheral devices configured to operate with one or more other components in computer system 100 to perform general or specific processing functions.

Network devices 112 include any suitable type, number, and configuration of network devices configured to allow computer system 100 to communicate across one or more networks (not shown). Network devices 112 may operate according to any suitable networking protocol and/or configuration to allow information to be transmitted by computer system 100 to a network or received by computer system 100 from a network.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method performed by a software transactional memory (STM) test generator in a computer system to generate STM test code, the method comprising:
inserting first transactional semantics configured to form a first transaction into non-STM test code; and
replacing a first method in the non-STM test code that is not supported by an STM system into a second method that is supported by the STM system; and
storing the non-STM test code with the first transactional semantics and the second method as the STM code on a computer-readable medium accessible by the computer system.

2. The method of claim 1 further comprising:
performing a functional analysis on the non-STM test code to identify the first method.

3. The method of claim 1 wherein the second method is configured to suppress the first method.

4. The method of claim 1 wherein the second method is a synthesized version of the first method.

5. The method of claim 1 further comprising:
inserting second transactional semantics configured to form a second transaction into the non-STM test code.

6. The method of claim 1 further comprising:
inserting second transactional semantics configured to cause the first transaction to be re-executed into the non-STM test code.

7. The method of claim 1 further comprising:
compiling the STM test code to generate executable STM test code; and
executing the executable STM test code to generate an STM test output.

8. The method of claim 7 further comprising:
comparing the STM test output to a non-STM test output corresponding to the non-STM test code to generate an STM test result; and
storing the STM test result in the computer-readable medium.

9. A method performed by a computer system, the method comprising:
compiling software transactional memory (STM) test code to generate executable STM test code, the STM test code generated from non-STM test code;
executing the executable STM test code to generate an STM test output; and
storing the STM test output in a computer-readable medium accessible by the computer system.

10. The method of claim 9 wherein executing the executable STM test code includes executing a transaction of the STM test code using an STM system in the computer system.

11. The method of claim 10 wherein executing the executable STM test code includes re-executing the transaction of the STM test code using the STM system.

12. The method of claim 9 wherein executing the executable STM test code includes executing a first version of a method in the STM test code that differs from a second version of the method in the non-STM test code.

13. The method of claim 9 further comprising:
comparing the STM test output to a non-STM test output corresponding to the non-STM test code to generate an STM test result; and
storing the STM test result in the computer-readable medium.

14. The method of claim 13 further comprising:
compiling the non-STM test code to generate executable non-STM test code;
executing the executable non-STM test code to generate a non-STM test output; and
storing the non-STM test output in the computer-readable medium.

15. A computer readable storage medium storing computer-executable instructions that, when executed by a computer system, perform a method of generating software transactional memory (STM) test code comprising:
inserting first transactional semantics configured to form a first transaction into non-STM test code; and
replacing a first method in the non-STM test code that is not supported by an STM system into a second method that is supported by the STM system; and
storing the non-STM test code with the first transactional semantics and the second method as the STM code on a computer-readable medium accessible by the computer system.

16. The computer readable storage medium of claim 15, wherein the second method is configured to suppress the first method.

17. The computer readable storage medium of claim 15, wherein the second method is a synthesized version of the first method.

18. The computer readable storage medium of claim 15, the method further comprising:
performing a functional analysis on the non-STM test code to identify the first method.

19. The computer readable storage medium of claim 18, the method further comprising:
inserting second transactional semantics configured to form a second transaction into the non-STM test code; and
inserting third transactional semantics configured to cause the first transaction to be re-executed into the non-STM test code.

20. The computer readable storage medium of claim 15, the method further comprising:
compiling the STM test code to generate executable STM test code; and
executing the executable STM test code to generate an STM test output.
